(19) United States
(12) Patent Application Publication
(10) Pub. No.: US 2025/0109459 A1
(43) Pub. Date: Apr. 3, 2025

(54) METHOD FOR RECOVERING METALS FROM METAL ALLOYS AND INTERMETALLICS

(71) Applicant: Montana Technological University, Butte, MT (US)

(72) Inventors: Mario Caccia, Butte, MT (US); Mitchell Harvey, Butte, MT (US); Courtney Young, Butte, MT (US)

(21) Appl. No.: 18/900,454

(22) Filed: Sep. 27, 2024

Related U.S. Application Data
(60) Provisional application No. 63/541,076, filed on Sep. 28, 2023.

(51) Int. Cl. C22B 59/00; C22B 3/22; C22B 3/44; C22B 5/12; C22B 7/00; H01M 10/54

(52) U.S. Cl. CPC C22B 59/00; C22B 3/22; C22B 3/44; C22B 5/12; C22B 7/002; H01M 10/54

(57) ABSTRACT

Disclosed herein are aspects of a method for recovering one or more metals from a feed comprising metal alloys, intermetallic compounds or a combination thereof. In certain aspects, the method can recover one or more metals of interest from waste streams comprising one or more permanent magnets, one or more lithium-ion battery anodes, or a combination thereof.

### CROSS REFERENCE TO RELATED APPLICATION

This application claims the benefit of and priority to the earlier filing date of U.S. Provisional Application No. 63/541,076, filed Sep. 28, 2023, which is incorporated herein by reference in its entirety.

### FIELD

The present disclosure concerns a method for recovering metals from metal alloys or intermetallics.

### BACKGROUND

The production and extraction of rare earth minerals (REMs) can result in the generation of substantial quantities of other elements including rare metals such as niobium, tantalum, cobalt, indium, zirconium, gallium, and lithium, which also play major roles in many energy and technology applications. Rare earth elements (REEs), however, are present in low quantities and are typically intermixed in Earth's crust, which pose challenges in the extraction and purification of REMs. Furthermore, the declining quality of modern REE ores in terms of both grade and liberation size poses further challenges to conventional processing methods, such as, flotation. Accordingly, there exists a need in the art for new methods of recovering metals from waste streams and REMs.

### SUMMARY

Disclosed herein is a method, comprising: providing a feed comprising one or more metal alloys, intermetallic compounds, or a combination thereof, into a reactor; introducing a gas comprising a reactive species (X) into the reactor; operating the reactor at a reaction temperature and under a reaction pressure sufficient to promote selective conversion of one or more metals of interest (Mᵢ) and form a material comprising: (i) a MᵢX-containing compound and (ii) a metal composite; quenching the material at a sufficient change in temperature to liberate the MᵢX-containing compound; and isolating the MᵢX-containing compound from the metal composite via physical separation or chemical separation.

A method for recovering one or more rare earth elements is also disclosed herein, the method comprising: providing a feed comprising one or more metal alloys, intermetallic compounds, or any combination thereof, into a reactor operated at a temperature ranging from 300° C. to 1700° C. and under a pressure ranging from 10⁻¹⁰ Torr to 2280 Torr; introducing a reactive species (X) into the reactor to promote forming a composite material according to Formula I(a),

RE_{z}X_{q}+y·TM Formula I(a)

where RE is a rare earth element, TM is a transition metal, z is an integer from 1 to 17, q is an integer from 1 to 17, and y is an integer from 1 to 17; liberating the RE_{z}X_{q}-containing compound via mechanical comminution, molten phase separation, or chemical leaching; isolating the RE_{z}X_{q}-containing compound from the composite material via physical separation or chemical separation; and subjecting the RE_{z}X_{q}-containing compound to electrolysis, gas phase reduction, or metallothermic reduction.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 is a schematic illustrating at least certain steps of a method according to aspects of the present disclosure, wherein a metal alloy or intermetallic compound is exposed to a reactive species, which selectively reacts with a metal of interest (Mᵢ) to form a material a material comprising a MᵢX-containing compound and a metal composite.

FIG. 2 is a schematic illustrating at least certain steps of a method according to aspects of the present disclosure, wherein one or more metal alloys or intermetallic compounds such as, but not limited to, RE-containing waste, is prepared as a feed and one or more metals of interest (Mᵢ), such as REs, are recovered.

FIG. 3 is a schematic illustrating at least certain steps of a method according to aspects of the present disclosure, wherein one or more Mᵢ are recovered from SmCo-based magnets.

FIG. 4A shows the x-ray diffraction pattern results obtained from a partially selectively oxidized SmCo magnet with the major peaks identified for Co, Co_{0.7}Fe_{0.3}, SmFeO₃, and Sm₂Co₁₇ (unreacted SmCo magnet).

FIG. 4B is an image showing the cross-section of a partially selectively oxidized SmCo magnet showing the microstructure of the metal oxides (dark grey, upper right), metals (light grey, upper right), and unoxidized magnet (light grey, lower right).

FIG. 5A is an image showing the cross section of the quenched and oxidized SmCo-based magnet exhibiting a crack in the oxidized layer.

FIG. 5B is an image showing the cross section of the quenched and oxidized SmCo-based magnet demonstrating the intact oxidized layer.

### DETAILED DESCRIPTION

### I. Overview of Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

The methods described herein should not be construed as limiting in any way. Instead, the present disclosure is directed toward all novel and non-obvious features and aspects of the present disclosure, alone and in various combinations and sub-combinations with one another. The disclosed methods are not limited to any specific aspect or feature or combinations thereof, nor do the disclosed methods require that any one or more specific advantages be present or problems be solved. Any theories of operation are to facilitate explanation, but the methods are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed devices and methods can be used in conjunction with other devices and methods. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. Furthermore, examples may be described with reference to directions indicated as “above,” “below,” “upper,” “lower,” and the like. These terms are used for convenient description, but do not imply any particular spatial orientation unless so indicated.

In some examples, values, procedures, or devices may be referred to as “lowest,” “best,” “minimum,” or the like. It will be appreciated that such descriptions are intended to indicate that a selection among many used functional alternatives can be made, and such selections need not be better, smaller, or otherwise preferable to other selections.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

The following terms and definitions are provided:

Rare Earth Element (REE): Refers to scandium (Sc), yttrium (Y), and lanthanide elements belonging to Group 3 in the long-period periodic table.

### II. Introduction

REEs include 17 metallic elements, which encompass scandium, yttrium, and the 15 lanthanides. They exhibit distinctive fluorescent, conductive, and magnetic characteristics, rendering suitable for a wide range of applications, such as advanced technological equipment, renewable energy systems, and manufacturing processes. As such, there is a need in the art for new methods of recovering REs from waste streams comprising one or more metal alloys and/or intermetallic compounds such as, but not limited to. rare-earth (RE)-based permanent magnets and lithium-ion battery anodes.

Furthermore, REEs are classified into three categories based on their physical and chemical properties: light (LREEs), middle (MREEs), and heavy (HREEs). LREEs typically consists of Scandium (Sc), Lanthanum (La), Cerium (Ce), Praseodymium (Pr), and Neodymium (Nd). MREEs include Samarium (Sm), Europium (Eu), Gadolinium (Gd), Terbium (Tb), and Dysprosium (Dy). HREEs comprise Holmium (Ho), Erbium (Er), Thulium (Tm), Ytterbium (Yb), Lutetium (Lu), and Yttrium (Y). Pm is virtually non-existent due to the radioactive nature of its isotopes which have half-lives too short to accumulate in nature. Moreover, the similarity of REE properties creates significant challenges in processing to separate them.

The present disclosure includes a novel method for recovering one or more metals from a feed comprising metal alloys and/or intermetallic compounds. In certain aspects, the metal alloy and/or intermetallic compounds comprise at least one metal that metal that is less noble than the constituent metals. In some aspects, the metal alloy can include, but are not limited to, rare-earth based permanent magnets having compositions RECo₅, RETM₁₇ and RETM₁₄B (where TM is a transition metal), which are utilized in applications including aerospace, electric vehicles, electronics, defense, and energy generation, and wind power. In particular aspects, the RE-based magnets can be SmCo-based magnets and NdFeB-based magnets.

### III. Method

Aspects of the present disclosure are directed to a method for selectively recovering and/or recycling a metal from a metal alloy or intermetallic compound. In certain aspects, the method comprises providing a feed comprising one or more metal alloys, intermetallic compounds, or a combination thereof, into a reactor; introducing a gas comprising a reactive species (X) into the reactor; operating the reactor at a reaction temperature and under a reaction pressure sufficient to promote selective conversion of one or more metals of interest (Mᵢ) and form a material comprising: (i) a MᵢX-containing compound and (ii) a metal composite; quenching the material at a sufficient change in temperature to liberate the MᵢX-containing compound; and isolating the MᵢX-containing compound from the metal composite via physical separation or chemical separation.

In some aspects, the feed can comprise a particle size ranging from greater than 0 mesh to 5000 mesh, such as from 4 mesh to 2500 mesh, 10 mesh to 2500 mesh, 50 mesh to 2500 mesh, 100 mesh to 2500 mesh, 500 mesh to 2500 mesh, 750 mesh to 25000 mesh, 1000 mesh to 2500 mesh, 1250 mesh to 2500 mesh, 1500 mesh to 2500 mesh, 2000 mesh to 2500 mesh.

In some aspects, the reactor is operated at a reaction temperature ranging from 100° C. to 2500° C., such as from 300° C. to 1700° C., 500° C. to 1700° C., 750° C. to 1700° C., 1000° C. to 1700° C., 1250° C. to 1700° C., 1500° C. to 1700° C.

In certain aspects, the reactor is operated under a reaction pressure ranging from 10⁻¹⁰ Torr to 2280 Torr. In some aspects, the partial pressure of the reactive species is controlled during heat treatment, wherein the selective reaction between a metal alloy or intermetallic compound and a gas stream comprising the reactive species promotes the selective conversion of one or more metals of interest (Mᵢ) to form a material comprising: (i) a MᵢX-containing compound and (ii) a metal composite.

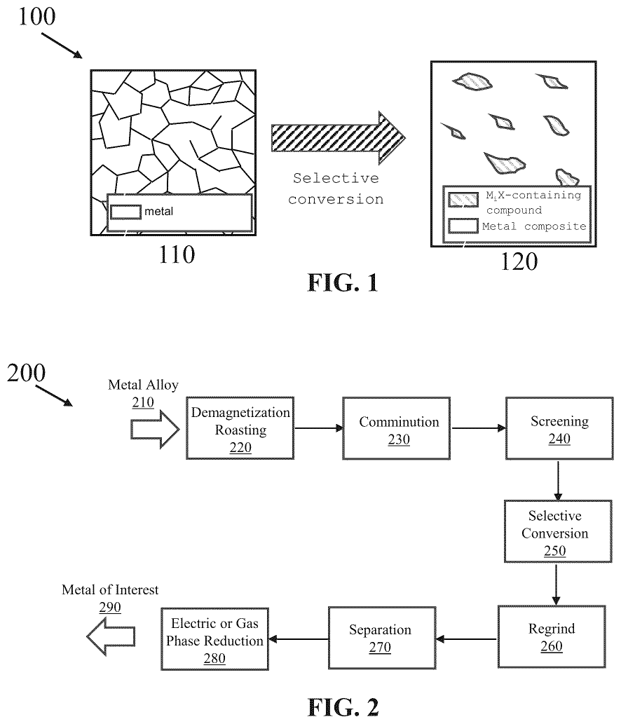

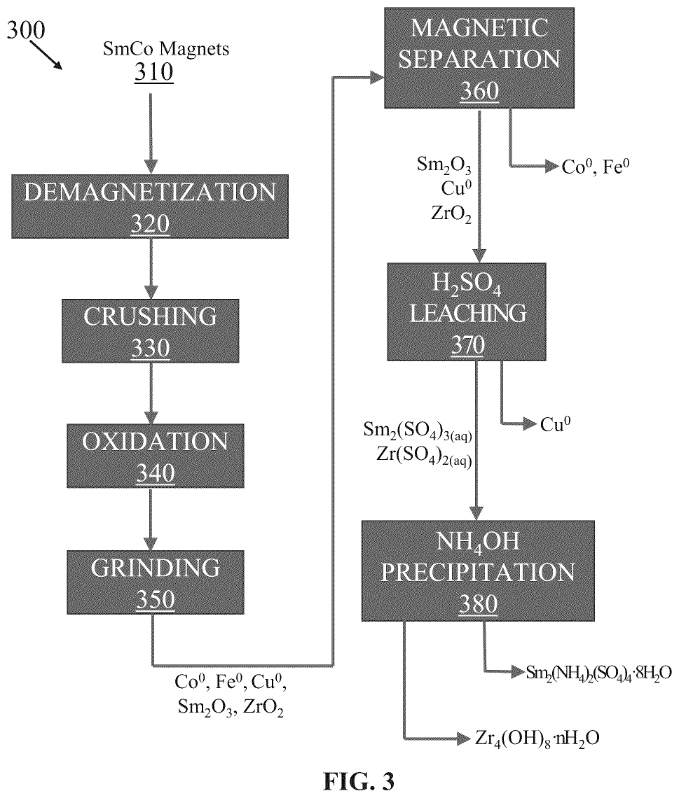

FIG. 1 is a schematic illustrating at least certain steps of the method disclosed herein 100, wherein a metal alloy comprising a metal of interest (Mᵢ) 110 is exposed to a reactive species, which selectively reacts with the Mᵢ to form a material 120 comprising a MᵢX-containing compound and a metal composite.

In aspects disclosed herein the Mᵢ can be a rare earth element (REE). In some aspects, the metal of interest (Mᵢ) is an alkali earth metal, alkaline earth metal, transition metal, post-transition metal, metalloid, or lanthanide. In certain aspects, the Mᵢ is selected from aluminum, antimony, arsenic, barite, beryllium, chromium, cobalt, copper, gallium, hafnium, lithium, magnesium, nickel, niobium, platinum, silicon, titanium, tantalum, tungsten, vanadium, zinc, zirconium, scandium, yttrium, lanthanum, cerium, dysprosium, neodymium, praseodymium, samarium, terbium, promethium, gadolinium, holmium, lutetium, thulium, ytterbium, europium, erbium, or any combination thereof.

In aspects disclosed herein, the reactive species (X) can be a reactive element in elemental form or other form. In aspects disclosed herein the reactive species is selected from oxygen, nitrogen, chlorine, iodine, fluorine, boron, or carbon. In certain aspects, the MᵢX-containing compound is an oxide, nitride, chloride, iodide, fluoride, boride, or carbide.

In particular aspects disclosed herein, the selective conversion of an RE element can be achieved by adjusting the partial pressure of the reactive species (X) in the gas stream to fall between the equilibrium partial pressure of the reaction that yields a RE_{z}X_{q}-containing compound and the reaction where X converts all elements present. In some aspects, the selective conversion of an RE element can be achieved according to Equation 1.

$${RE}_{z} {TM}_{y} + \frac{a}{q} \cdot {X}_{q} ↔ {RE}_{z} {X}_{a} + y \cdot TM \qquad ( Equation l )$$

Where TM is a transition metal, z is an integer from 1 to 17, q is an integer from 1 to 17, and y is an integer from 1 to 17.

In particular aspects disclosed herein, the partial pressure of oxygen is controlled during heat treatment. For example, the selective conversion of the RE element can be achieved by adjusting the partial pressure of the reactive species (X) in the gas stream to fall between the equilibrium partial pressure of the reaction that yields the RE_{z}X_{q}-containing compound and the reaction where X converts all elements present. In aspects disclosed herein, the RE_{z}X_{q}-containing compound can be selected from REₓB_{y}, REₓC_{y}, REₓN_{y}, REₓO_{y}, REFₓ, REClₓ, REBrₓ, or REIₓ, where x is the oxidation state of the RE.

In certain aspects, the partial pressure of oxygen is kept between 1.9×10⁻²⁰ and 1.3×10⁻⁴⁸ atm. In other aspects, the partial pressure of oxygen is between 2.1×10⁻³⁴ and 1.3×10⁻⁴³ atm.

In some aspects, the metal phase in a ceramic/metal composite can be selectively converted and separated from the ceramic phase for the recycling of both phases. In certain aspects, the method can comprise the selective chlorination of Co in WC/Co ceramic/metal composites by adjusting the partial pressure of chlorine in the atmosphere according to Equation 2:

$$WC ( s ) + Co ( s ) + {Cl}_{2} ( g ) ⇌ WC ( s ) + {CoCl}_{2} ( s ) \qquad ( Equation 2 )$$

In a non-limiting example, the partial pressure of chlorine is adjusted between 3.7×10⁻⁹ and 1.3×10⁻²⁰ atm.

In view of the expansive nature of the conversion process, and the differences in coefficients of thermal expansion between the MᵢX-containing compound and the metal composite, stress gradients can generate across the MᵢX-containing compound and the metal composite. The strain gradient can facilitate interfacial cracking and debonding, which can aid in liberating the MᵢX-containing compound.

In some aspects, the selective conversion of one or more metals of interest (Mᵢ) can produce a strain gradient strain. In certain aspects, the selective conversion can produce a strain which can be determined by Equation 3.

$$ε = \frac{Δ {V}_{m}}{{V}_{0}} \qquad ( Equation 3 )$$

Where ε is strain, ΔVₘ is the molar volume change of the solid phases, and V₀ is the initial molar volume.

In certain aspects, the strain gradients can be increased by using a quench heat treatment to aid in the mechanical liberation of the MᵢX-containing compound. In particular aspects disclosed herein, the material comprising the MᵢX-containing compound and the metal composite is quenched at a sufficient temperature to liberate the MᵢX-containing compound from the material. In certain aspects, the quenching of the material can comprise a change temperature ranging from 2500° C. to 100° C., such as from 2000° C. to 150° C., 1900° C. to 200° C., 1800° C. to 250° C., 1700° C. to 273° C., 1500° C. to 273° C., 1200° C. to 273° C., 1000° C. to 273° C., or 800° C. to 273° C.

In some aspects, the MᵢX-containing compound is isolated from the metal composite via physical separation or chemical separation. In particular aspects, the MᵢX-containing compound is isolated from the composite material via magnetic separation, electrostatic separation, gravity separation, flotation, or chemical leaching.

In certain aspects, the method can further comprise recovering the MᵢX-containing compound via solvent extraction, resin adsorption, or chemical precipitation.

In some aspects the method can further comprise recovering the Mᵢ via electrolysis, gas phase reduction, or metallothermic reduction.

In particular aspects disclosed herein, the method can be used to recycle critical metals and materials (non-metallic) from ceramic/metal composites. The metal phase in the ceramic/metal composite can be selectively converted utilizing the method disclosed herein and separated from the ceramic phase for the recycling of both phases.

In certain aspects, the method can be used to recover critical metals and rare earth metals from waste streams comprising, but not limited to, permanent magnets and Li-ion battery anodes. FIG. 2 is a schematic illustrating at least certain steps of the method disclosed herein 200, wherein RE-containing waste 210, is prepared via demagnetization roasting 220, comminution 230, screening 240, RE-selective conversion 250, quenching 260 isolating, and electrolysis or gas phase reduction 270.

In some aspects, the method can be used to recover rare earth metals from RE-based permanent magnets having compositions RECo₅, RETM₁₇ and RETM₁₄B such as, but not limited to, SmCo-based magnets comprising Sm, Co, Pr; and NdFeB-based magnets comprising Nd, Fe, B and Dy. FIG. 2 is a schematic illustrating at least certain steps of the method disclosed herein 300, wherein SmCo magnets 310 are prepared via demagnetization 320, crushing 330; fed into a reactor for selective conversion of a metal of interest 340; and the resulting products are subjected to grinding 350 and isolated via magnetic separation 360; and the resulting constituents are recovered via chemical leaching (e.g., H₂SO₄) 370 and chemical precipitation (e.g., NH₄OH) 380.

### IV. Overview of Several Aspects

Disclosed herein are aspects of a method, comprising: providing a feed comprising one or more metal alloys, intermetallic compounds, or a combination thereof, into a reactor; introducing a gas comprising a reactive species (X) into the reactor; operating the reactor at a reaction temperature and under a reaction pressure sufficient to promote selective conversion of one or more metals of interest (Mᵢ) and form a material comprising: (i) a MᵢX-containing compound and (ii) a metal composite; quenching the material at a sufficient change in temperature to liberate the MᵢX-containing compound; and isolating the MᵢX-containing compound from the metal composite via physical separation or chemical separation.

In any or all aspects, the feed has a particle size ranging from 4 mesh to 2500 mesh.

In any or all the above aspects, the feed is a metal solid solution.

In any or all the above aspects, the reactor is operated at a reaction temperature ranging from 300° C. to 1700° C.

In any or all the above aspects, the reactor is operated under a reaction pressure ranging from 10⁻¹⁰ Torr to 2280 Torr.

In any or all the above aspects, the metal of interest (Mᵢ) is an alkali earth metal, alkaline earth metal, transition metal, post-transition metal, metalloid, or lanthanide.

In any or all the above aspects, the metal of interest (Mᵢ) is selected from aluminum, antimony, arsenic, barite, beryllium, chromium, cobalt, copper, gallium, hafnium, lithium, magnesium, nickel, niobium, platinum, silicon, titanium, tantalum, tungsten, vanadium, zinc, zirconium, scandium, yttrium, lanthanum, cerium, dysprosium, neodymium, praseodymium, samarium, terbium, promethium, gadolinium, holmium, lutetium, thulium, ytterbium, europium, erbium, or any combination thereof.

In any or all the above aspects, the reactive species (X) is selected from oxygen, nitrogen, chlorine, iodine, fluorine, boron, or carbon.

In any or all the above aspects, the MᵢX-containing compound is an oxide, nitride, chloride, iodide, fluoride, boride, or carbide.

In any or all the above aspects, quenching the material comprises a change in temperature ranging from 1700° C. to 273° C.

In any or all the above aspects, isolating the MᵢX-containing compound from the composite material comprises magnetic separation, electrostatic separation, gravity separation, flotation, or chemical leaching.

In any or all the above aspects, the method further comprises recovering the MᵢX-containing compound by solvent extraction, resin adsorption, or chemical precipitation.

In any or all the above aspects, the method further comprises recovering the Mᵢ via electrolysis, gas phase reduction, or metallothermic reduction.

A method for recovering one or more rare earth elements is also disclosed herein, the method comprising: providing a feed comprising one or more metal alloys, intermetallic compounds, or any combination thereof, into a reactor operated at a temperature ranging from 300° C. to 1700° C. and under a pressure ranging from 10⁻¹⁰ Torr to 2280 Torr; introducing a reactive species (X) into the reactor to promote forming a composite material according to Formula I(a),

$$R {E}_{z} {X}_{q} + y \cdot TM \qquad Formula I ( a )$$

where RE is a rare earth element, TM is a transition metal, z is an integer from 1 to 17, q is an integer from 1 to 17, and y is an integer from 1 to 17; liberating the RE_{z}X_{q}-containing compound via mechanical comminution, molten phase separation, or chemical leaching; isolating the RE_{z}X_{q}-containing compound from the composite material via physical separation or chemical separation; and subjecting the RE_{z}X_{q}-containing compound to electrolysis, gas phase reduction, or metallothermic reduction.

In any or all the above aspects, the feed comprises comprise at least one metal less noble than the remaining constituent metals.

In any or all the above aspects, the feed further comprises one or more ceramic materials.

In any or all the above aspects, the reactive species is selected from B, C, N, O, F, Cl, Br, or I.

In any or all the above aspects, the composite material comprises RE₂O_{z}, REF_{z}, RECl_{z}, REI_{z}, RE₃Nₓ, RE₄Cx, or REBₓ, where x is the oxidation state of the rare earth element.

In any or all the above aspects, the feed comprises one or more permanent magnets, one or more lithium-ion battery anodes, or a combination thereof.

In any or all the above aspects, the rare earth element is selected from aluminum, antimony, arsenic, barite, beryllium, chromium, cobalt, copper, gallium, hafnium, lithium, magnesium, nickel, niobium, platinum, silicon, titanium, tantalum, tungsten, vanadium, zinc, zirconium, scandium, yttrium, lanthanum, cerium, dysprosium, neodymium, praseodymium, samarium, terbium, promethium, gadolinium, holmium, lutetium, thulium, ytterbium, europium, or erbium.

### V. Examples

### Example 1

In this example, the selective oxidation of Sm in SmCo-based magnets by controlling the partial pressure of oxygen (pO₂) during heat treatment was investigated. In view of the oxidation reactions for pure Sm and pure shown in Equation 7 and Equation 8:

$$2 {Sm}_{( s )} + \frac{3}{2} {O}_{2 ( g )} ⇌ {Sm}_{2} {O}_{3 ( s )} \qquad ( Equation 7 )$$

$${Co}_{( s )} + \frac{1}{2} {O}_{2 ( g )} ⇌ {CoO}_{( s )} \qquad ( Equation 8 )$$

the equilibrium oxygen partial pressure (p_{O}_{₂}_{,eq}) between Sm and Sm₂O₃ is 2.8×10⁻⁴⁸ atm at 827° C. while the p_{O}_{₂}_{,eq} between Co and CoO is 1.3×10⁻¹⁵ atm at the same temperature, which indicates that if the oxygen partial pressure in the atmosphere is kept at or below 1.3×10¹⁵ atm, only Sm will oxidize. Sm and Co, however, are not present as pure metals in Sm—Co magnets; rather, they are found as intermetallic compounds, namely Sm₂Co₁₇ in second-generation Sm—Co magnets. The oxidation of the intermetallic compound Sm₂Co₁₇ at low oxygen partial pressures can follow either reactions shown in Equation 9 or Equation 10.

$$S {m}_{2} {Co}_{17 ( s )} + \frac{3}{2} {O}_{2 ( g )} ⇌ {Sm}_{2} {O}_{3 ( s )} + 17 {Co}_{( s )} \qquad ( Equation 9 )$$

$${Sm}_{2} {Co}_{17 ( s )} + 10 {O}_{2 ( g )} ⇌ {Sm}_{2} {O}_{3 ( s )} + 17 {CoO}_{( s )} \qquad ( Equation 10 )$$

Unlike the oxidation of the pure metals, the free energy of formation of the intermetallic is not zero and will thus affect the equilibrium oxygen partial pressure for each reaction. As such, the partial oxidation of Sm₂Co₁₇ to Sm₂O₃ and Co has a p_{O}_{₂}_{,eq} of 1.3×10⁻⁴⁸ atm, and the complete oxidation of Sm₂Co₁₇ to Sm₂O₃ and CoO has a p_{O}_{₂}_{,eq} of 1.9×10⁻²⁰ atm. Thus, the partial pressure of oxygen was kept between 1.9×10⁻²⁰ and 1.3×10⁻⁴⁸ atm to selectively oxidize Sm but not Co during the heat treatment.

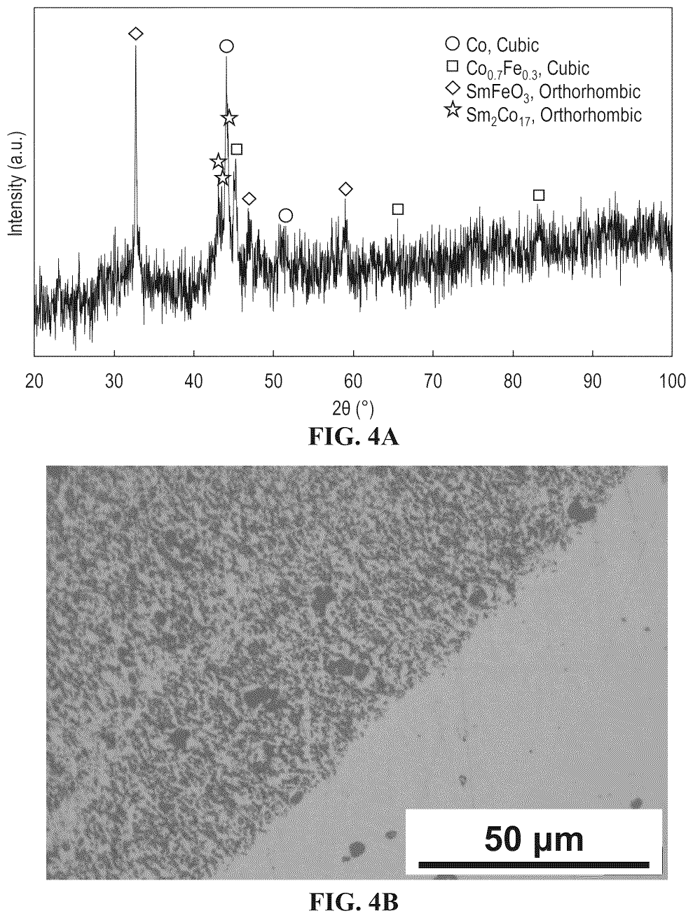

FIG. 4A shows the x-ray diffraction pattern results obtained a partially selectively oxidized SmCo magnet with the major peaks identified for Co, Co_{0.7}Fe_{0.3}, SmFeO₃, and Sm₂Co₁₇ (unreacted SmCo magnet).

FIG. 4B is an image showing the cross-section of a partially selectively oxidized SmCo magnet showing the microstructure of the metal oxides (dark grey, upper right), metals (light grey, upper right), and unoxidized magnet (light grey, lower right).

This example demonstrates that by controlling the partial pressure of oxygen (pO₂) during heat treatment, the Sm in Sm—Co-based magnets was selectively oxidized to create a composite of Sm₂O₃ dispersed in a Co metal matrix and for Sm₂Co₁₇ magnets, the composite will be 30 vol. % Sm₂O₃ and 70 vol % Co after oxidation.

### Example 2

In this example, the selective oxidation of Nd in Nd in NdFeB-based magnets by controlling the partial pressure was investigated. A typical Nd₂Fe₁₄B magnet comprises about 30 wt % Nd, 64 wt % Fe. 1 wt % B and small amounts (<1 wt %) of other metals such as Nb, Al and Dy. Considering the oxidation reactions shown in Equations 11-13 for the pure main metals:

$$2 {Nd}_{( s )} + \frac{3}{2} {O}_{2 ( g )} ⇌ {Nd}_{2} {O}_{3 ( s )} \qquad ( Equation 11 )$$

$${Fe}_{( s )} + \frac{1}{2} {O}_{2 ( g )} ⇌ {FeO}_{( s )} \qquad ( Equation 12 )$$

$$2 {B}_{( s )} + \frac{3}{2} {O}_{2 ( g )} ⇌ {B}_{2} {O}_{3 ( s )} \qquad ( Equation 13 )$$

the equilibrium oxygen partial pressure (p_{O}_{₂}_{,eq}) between Nd and Nd₂O₃ is 1.66×10⁻³⁹ atm at 1000° C. while the pO₂,eq between Fe and FeO and between B and B₂O₃ are 5.73×10⁻¹⁶ atm and 2.03×10⁻²⁶ atm respectively at the same temperature, which indicates that if the oxygen partial pressure in the atmosphere is kept at or below 2.03×10⁻²⁶ atm, only Nd will oxidize. Nd, Fe and B, however, are not present as pure metals in NdFeB-based magnets, rather they are found, predominantly, as the ternary intermetallic compound Nd₂Fe₁₄B. The oxidation of the intermetallic compound Nd₂Fe₁₄B at low oxygen partial pressures can follow Equation 14.

$${Nd}_{2} {Fe}_{14} B + \frac{3}{2} {O}_{2 ( g )} \to N {d}_{2} {O}_{3 ( s )} + 13 Fe + FeB \qquad ( Equation 14 )$$

Unlike the oxidation of the pure metals, the free energy of formation of the intermetallic is not zero and thus affect the equilibrium oxygen partial pressure for each reaction. As such, the partial oxidation of Nd₂Fe₁₄B to Nd₂O₃ and Fe+FeB has a p_{O}_{₂}_{,eq} of 4.3×10⁻⁴³ atm. B is more sensitive to oxidation than Fe, in view of the partial oxidation of the magnet to form both Nd₂O₃ and B₂O₃, the p_{O}_{₂}_{,eq} would be 2.1×10⁻³⁴ atm. Thus, the partial pressure of oxygen is kept between 2.1×10⁻³⁴ and 1.3×10⁻⁴³ atm to selectively oxidize Nd but not Fe or B during the heat treatment.

This example demonstrates that by controlling the partial pressure of oxygen (pO₂) during heat treatment, the Nd in NdFeB-based magnets was selectively oxidized to create a composite of Nd₂O₃ dispersed in an Fe plus FeB matrix.

### Example 3

In this example, the strain gradient that developed during the selective oxidation of Sm in a SmCo-based magnet was investigated. The strain induced in the material upon partial oxidation of Sm (ε_{reac}) was approximated as the molar volume change of the solid phases during reaction 4. Complete oxidation of the Sm in Sm₂Co₁₇ resulted in a 7.6% volume increase, which caused strain to develop within the oxidized magnets. The theoretical strain in the oxidized magnets was calculated according to equation 15.

$$ε = \frac{Δ {V}_{m}}{{V}_{0}} = \frac{{V}_{{Sm}_{2} {O}_{3}} + 17 \cdot {V}_{Co} - {V}_{{Sm}_{2} {Co}_{17}}}{{V}_{{Sm}_{2} {Co}_{17}}} \qquad ( Equation 15 )$$

where ε is strain, ΔVₘ is the molar volume change of the solid phases, and V₀ is the initial molar volume. 7.6% strain causes interfacial stresses that facilitates interfacial cracking between Sm₂O₃ and Co. Additionally, thermal strain (εₜₕₑᵣₘ) will develop during cool down of the oxidized magnets due to the differences in coefficient of thermal expansion of the products. Sm₂O₃ and Co have different coefficients of thermal expansion (8.5×10⁻⁶ and 13.2×10⁻⁶° C.⁻¹ respectively in the range of 25-950° C.) that will cause additional stresses to develop at the Sm₂O₃/Co interfaces. An estimation of the linear strain across a Sm₂O₃/Co interface when cooling down from 1000° C. to 25° C. yields a value of 0.45%. Furthermore, upon cooling, cobalt contracts 0.3% when it undergoes a martensitic phase transformation (εₜᵣₐₙₛ) from a face centered cubic crystal (FCC) structure to hexagonal close packed (HCP) structure around 417° C.

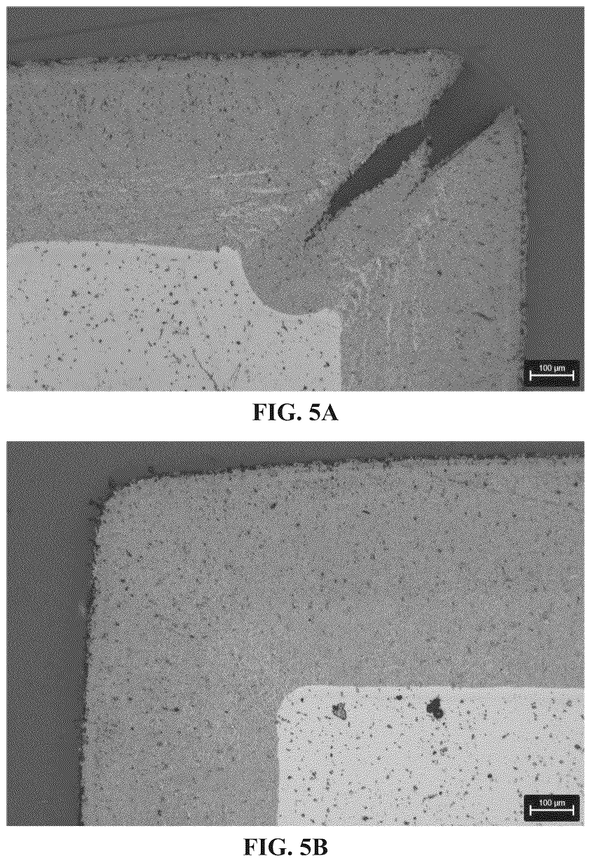

FIG. 5A is an image showing the cross section of the quenched and oxidized SmCo-based magnet exhibiting a crack in the oxidized layer. FIG. 5B is an image showing the cross section of the quenched and oxidized SmCo-based magnet demonstrating the intact oxidized layer.

As such, the summation of the strains (εₜₒₜ) cause stress gradients across the Sm₂O₃/Co interface which can lead to interfacial cracking and debonding; thus, aiding in the separation of both phases and their subsequent recycling.

### Example 4

In this example, the stress gradient that developed during selective oxidation of Nd in NdFeB-based magnets was investigated. The strain induced in the material upon partial oxidation of Nd (ε_{reac}) was approximated as the molar volume change of the solid phases during reaction. Complete oxidation of the Nd in Nd₂Fe₁₄B resulted in a 3.9% volume increase, which caused strain to develop within the oxidized magnets. The theoretical strain in the oxidized magnets was calculated according to Equation 16.

$$ε = \frac{Δ {V}_{m}}{{V}_{0}} = \frac{{V}_{{Nd}_{2} {O}_{3}} + 13 \cdot {V}_{F e} + {V}_{F e {B}^{-}} {V}_{{Nd}_{2} F {e}_{14} B}}{{V}_{{Nd}_{2} F {e}_{14} B}} \qquad ( Equation 16 )$$

Where, ε is strain, ΔVₘ is the molar volume change of the solid phases, and V₀ is the initial molar volume. 3.9% strain causes interfacial cracking. Additionally, thermal strain (εₜₕₑᵣₘ) developed during cool down of the oxidized magnets due to the differences in coefficients of thermal expansion of the products. Nd₂O₃ and Fe have different coefficients of thermal expansion (10×10⁻⁶ and 12.2×10⁻⁶° C.⁻¹ respectively in the range of 25-1000° C.), which cause additional stresses to develop at the Nd₂O₃/Fe interfaces. An estimation of the linear strain across a Nd₂O₃/Fe interface cooling down from 1000° C. to 25° C. yields a value of 0.24%. Furthermore, upon cooling, Fe contracts 4.1% when it undergoes a phase transformation (εₜᵣₐₙₛ), from a face centered cubic crystal (FCC) structure to a body centered cubic (BCC) at 911° C.

The summation of these strains (εₜₒₜ) will cause significant stress gradients across the Nd₂O₃/Fe interface which can lead to interfacial cracking and debonding and thus aid in the separation of both phases and their subsequent recycling.

### Example 5

In this example, the recycling of metals and materials (non-metallic) from ceramic/metal composites was investigated. The metal phase Co in the ceramic/metal composite WC/Co used in machining tools was selectively converted and separated from the ceramic phase for the recycling of both phases.

By adjusting the partial pressure of chlorine in the atmosphere Co was selectively chlorinated according to Equation 2. Accordingly, the equilibrium chlorine partial pressure (p_{Cl}_{ᵢ}_{,eq}) between Co and CoCl₂ is 1.3×10⁻²⁰ atm while the p_{Cl}_{₂}_{,eq} between WC/WCl₆ is 3.7×10⁻⁹ atm. Thus, the partial pressure of chlorine was adjusted between 3.7×10⁻⁹ and 1.3×10⁻²⁰ atm, to only chlorinate Co. Subsequent separation of the ceramic and chlorinated metal can be done by leaching with water and the Co metal can then be recovered by electrolysis.

In view of the many possible aspects to which the principles of the present disclosure may be applied, it should be recognized that the illustrated aspects are only preferred examples of the present disclosure and should not be taken as limiting the scope of the present disclosure. Rather, the scope of the present disclosure is defined by the following claims. We therefore claim as our present disclosure all that comes within the scope and spirit of these claims.

1. A method, comprising:
providing a feed comprising one or more metal alloys, intermetallic compounds, or a combination thereof, into a reactor;
introducing a gas comprising a reactive species (X) into the reactor;
operating the reactor at a reaction temperature and under a reaction pressure sufficient to promote selective conversion of one or more metals of interest (Mᵢ) and form a material comprising: (i) a MᵢX-containing compound and (ii) a metal composite;
quenching the material at a sufficient change in temperature to liberate the MᵢX-containing compound; and
isolating the MᵢX-containing compound from the metal composite via physical separation or chemical separation.

2. The method of claim 1, wherein the feed has a particle size ranging from 4 mesh to 2500 mesh.

3. The method of claim 1, wherein the feed is a metal solid solution.

4. The method of claim 1, wherein the reactor is operated at a reaction temperature ranging from 300° C. to 1700° C.

5. The method of claim 1, wherein the reactor is operated under a reaction pressure ranging from 10⁻¹⁰ Torr to 2280 Torr.

6. The method of claim 1, wherein the metal of interest (Mᵢ) is an alkali earth metal, alkaline earth metal, transition metal, post-transition metal, metalloid, or lanthanide.

7. The method of claim 6, wherein the metal of interest (Mᵢ) is selected from aluminum, antimony, arsenic, barite, beryllium, chromium, cobalt, copper, gallium, hafnium, lithium, magnesium, nickel, niobium, platinum, silicon, titanium, tantalum, tungsten, vanadium, zinc, zirconium, scandium, yttrium, lanthanum, cerium, dysprosium, neodymium, praseodymium, samarium, terbium, promethium, gadolinium, holmium, lutetium, thulium, ytterbium, europium, erbium, or any combination thereof.

8. The method of claim 1, wherein the reactive species (X) is selected from oxygen, nitrogen, chlorine, iodine, fluorine, boron, or carbon.

9. The method of claim 1, wherein the MᵢX-containing compound is an oxide, nitride, chloride, iodide, fluoride, boride, or carbide.

10. The method of claim 1, wherein quenching the material comprises a change in temperature ranging from 1700° C. to 273° C.

11. The method of claim 1, wherein isolating the MᵢX-containing compound from the composite material comprises magnetic separation, electrostatic separation, gravity separation, flotation, or chemical leaching.

12. The method of claim 11, further comprising recovering the MᵢX-containing compound by solvent extraction, resin adsorption, or chemical precipitation.

13. The method of claim 1, further comprising recovering the Mᵢ via electrolysis, gas phase reduction, or metallothermic reduction.

14. A method for recovering one or more rare earth elements, the method comprising:
providing a feed comprising one or more metal alloys, intermetallic compounds, or any combination thereof, into a reactor operated at a temperature ranging from 300° C. to 1700° C. and under a pressure ranging from 10⁻¹⁰ Torr to 2280 Torr;
introducing a reactive species (X) into the reactor to promote forming a composite material according to Formula I(a),
RE_{z}X_{q}+y·TM Formula I(a)
where RE is a rare earth element, TM is a transition metal, z is an integer from 1 to 17, q is an integer from 1 to 17, and y is an integer from 1 to 17;
liberating the RE_{z}X_{q}-containing compound via mechanical comminution, molten phase separation, or chemical leaching;
isolating the RE_{z}X_{q}-containing compound from the composite material via physical separation or chemical separation; and
subjecting the RE_{z}X_{q}-containing compound to electrolysis, gas phase reduction, or metallothermic reduction.

15. The method of claim 14, wherein the feed comprises comprise at least one metal less noble than the remaining constituent metals.

16. The method of claim 14, wherein the feed further comprises one or more ceramic materials.

17. The method of claim 14, wherein the reactive species is selected from B, C, N, O, F, Cl, Br, or I.

18. The method of claim 17, wherein the composite material comprises RE₂O_{z}, REF_{z}, RECl_{z}, REI_{z}, RE₃Nₓ, RE₄Cx, or REBₓ, where x is the oxidation state of the rare earth element.

19. The method of claim 14, wherein the feed comprises one or more permanent magnets, one or more lithium-ion battery anodes, or a combination thereof.

20. The method of claim 14, wherein the rare earth element is selected from aluminum, antimony, arsenic, barite, beryllium, chromium, cobalt, copper, gallium, hafnium, lithium, magnesium, nickel, niobium, platinum, silicon, titanium, tantalum, tungsten, vanadium, zinc, zirconium, scandium, yttrium, lanthanum, cerium, dysprosium, neodymium, praseodymium, samarium, terbium, promethium, gadolinium, holmium, lutetium, thulium, ytterbium, europium, or erbium.
